(19) United States
(12) Patent Application Publication
(10) Pub. No.: US 2026/0015043 A1
(43) Pub. Date: Jan. 15, 2026

(54) VEHICLE FRONT-PORTION STRUCTURE

(71) Applicant: TOYOTA JIDOSHA KABUSHIKI KAISHA, Toyota-shi (JP)

(72) Inventors: Soshiro Murata, Toyota-shi (JP); Koji Saeki, Okazaki-shi (JP); Yuzuru Shiota, Nagoya-shi (JP); Shuhei Niwata, Miyoshi-shi (JP); Ryosuke Fukui, Aichi-gun (JP)

(73) Assignee: TOYOTA JIDOSHA KABUSHIKI KAISHA, Toyota-shi (JP)

(21) Appl. No.: 19/232,066

(22) Filed: Jun. 9, 2025

(30) Foreign Application Priority Data
Jul. 12, 2024 (JP) 2024-112853

(51) Int. Cl. B62D 25/08; B60S 1/04; B62D 25/16

(52) U.S. Cl. CPC B62D 25/088; B60S 1/0461; B62D 25/16

(57) ABSTRACT

A vehicle front-portion structure includes: a framework portion including a pair of member portions extending in a front-rear direction at both side portions in a vehicle width direction in a front portion of a vehicle, each of the member portions having a part including a through-hole, and a suspension tower portion. The vehicle front-portion structure includes a front windshield glass that separates an inside of a vehicle cabin and an outside of the vehicle cabin, and a wiper device fixed to the member portion in a state in which a part of the wiper device is disposed inside of the through-hole. The wiper device includes a wiper, and a wiper arm that supports the wiper and has a pivoting position positioned on an inner side in the vehicle width direction from the through-hole.

### CROSS-REFERENCE TO RELATED APPLICATION

This application claims priority to Japanese Patent Application No. 2024-112853 filed on Jul. 12, 2024, incorporated herein by reference in its entirety.

### BACKGROUND

### 1. Technical Field

The present disclosure relates to a vehicle front-portion structure.

### 2. Description of Related Art

Japanese Unexamined Patent Application Publication No. 2021-079776 (JP 2021-079776 A) discloses a wiper drive unit that drives a wiper for use in wiping a front windshield glass of a vehicle. On a lower side of the front windshield glass in a front portion of the vehicle described in this literature, a cowl portion including a dash panel and a cowl front panel is provided. Further, the wiper drive unit is fixed to the dash panel and the cowl front panel in a state of being disposed in the cowl portion.

### SUMMARY

Incidentally, depending on the design of the vehicle, it may be desired to adopt a low-hood structure in the front portion of the vehicle. In this case, in order to ensure a range to be wiped by the wiper, it is considered that disposing a wiper driver for use in driving the wiper along a side portion on an outer side in a vehicle width direction in the front portion of the vehicle is desirable, but the configuration described in JP 2021-079776 A does not consider this point.

The present disclosure provides a vehicle front-portion structure that makes it possible to ensure good visibility even in a vehicle adopting a low-hood structure from the viewpoint of design.

A vehicle front-portion structure of a first aspect includes: a die-cast framework portion including a pair of member portions extending in a vehicle front-rear direction at both side portions in a vehicle width direction in a front portion of a vehicle, each of the member portions having a part including a through-hole, and a suspension tower portion provided to swell to an inner side in the vehicle width direction, the through-hole being disposed on an outer side in the vehicle width direction from the suspension tower portion; a front windshield glass provided on a vehicle rear side from the member portions in the front portion of the vehicle, the front windshield glass separating an inside of a vehicle cabin of the vehicle and an outside of the vehicle cabin; and a wiper device including a wiper configured to wipe the front windshield glass, and a wiper arm that supports the wiper and has a pivoting position that is positioned on the inner side in the vehicle width direction from the through-hole, the wiper device being fixed to each of the member portions in a state in which at least a part of the wiper device is disposed inside of the through-hole.

In the front portion of the vehicle to which the vehicle front-portion structure of the first aspect is applied, the die-cast framework portion including the member portions is provided. Further, the through-hole is provided on the outer side in the vehicle width direction from the suspension tower portion in each of the member portions of the framework portion. Further, at least a part of the wiper device including the wiper for use in wiping the front windshield glass and the wiper arm that supports the wiper is fixed to each of the member portions in a state of being disposed inside of the through-hole provided in each of the member portions of the framework portion. As described above, in the vehicle front-portion structure of the first aspect, at least a part of the wiper device can be disposed along a part on the outer side in the vehicle width direction in the front portion of the vehicle. As a result, even in a case of a vehicle adopting a low-hood structure from the viewpoint of design, as compared with a case in which the wiper driver is disposed in a part on the inner side in the vehicle width direction in the front portion of the vehicle, a wider wiping range of the wiper can be ensured.

As a vehicle front-portion structure of a second aspect, in the vehicle front-portion structure of the first aspect, the wiper device may include a wiper driver configured to tilt the wiper arm, and the wiper driver may be fixed to each of the member portions in a state in which at least a part of the wiper driver is disposed inside of the through-hole.

In the vehicle front-portion structure of the second aspect, at least a part of the wiper driver is fixed to each of the member portions in the state of being disposed inside of the through-hole provided in each of the member portions of the framework portion. As described above, in the vehicle front-portion structure of the second aspect, the wiper driver can be disposed along a part on the outer side in the vehicle width direction in the front portion of the vehicle. As a result, even in a case of a vehicle adopting a low-hood structure from the viewpoint of design, as compared with the case in which the wiper driver is disposed in a part on the inner side in the vehicle width direction in the front portion of the vehicle, a wider wiping range of the wiper can be ensured.

As a vehicle front-portion structure of a third aspect, in the vehicle front-portion structure of the first aspect or the second aspect, a dimension of the front windshield glass in the vehicle front-rear direction may be longer than a dimension of the front windshield glass in the vehicle width direction.

In the vehicle front-portion structure of the third aspect, the wiper driver can be disposed along a part on the outer side in the vehicle width direction in the front portion of the vehicle, and hence it is possible to achieve a design having a configuration in which the dimension of the front windshield glass in the vehicle front-rear direction is longer than the dimension of the front windshield glass in the vehicle width direction.

As a vehicle front-portion structure of a fourth aspect, in the vehicle front-portion structure of any one of the first aspect to the third aspect, each of the member portions may have an opened hollow sectional shape in which the outer side in the vehicle width direction is opened, and the through-hole may be provided in a vertical wall extending in the vehicle front-rear direction and a vehicle-height direction. On the vertical wall, a cylindrical portion may be provided to rise from a peripheral edge portion of the through-hole in a plate thickness direction of the vertical wall, and reinforcement ribs that reinforce the cylindrical portion may be integrally provided around the cylindrical portion.

In the vehicle front-portion structure of the fourth aspect, each of the member portions has the opened hollow sectional shape in which the outer side in the vehicle width direction is opened. In this configuration, as compared with a configuration in which the member portion is solid, the framework portion can be reduced in weight. Further, the reinforcement ribs that reinforce the cylindrical portion are integrally provided around the cylindrical portion. In this manner, the cylindrical portion can be reinforced.

As a vehicle front-portion structure of a fifth aspect, in the vehicle front-portion structure of the fourth aspect, the reinforcement ribs may extend in at least one of the vehicle front-rear direction and the vehicle-height direction.

In the vehicle front-portion structure of the fifth aspect, the reinforcement ribs extend in at least one of the vehicle front-rear direction and the vehicle-height direction. In a configuration in which the reinforcement ribs extend in the vehicle front-rear direction, the tilt in the vehicle front-rear direction of a cylindrical part forming the through-hole can be prevented. Further, in a configuration in which the reinforcement ribs extend in the vehicle-height direction, the tilt in the vehicle-height direction of the cylindrical part forming the through-hole can be prevented.

As a vehicle front-portion structure of a sixth aspect, in the vehicle front-portion structure of any one of the second aspect or the third aspect to the fifth aspect including the second aspect, at least a part of the wiper driver may be positioned on the outer side in the vehicle width direction from an end of the front windshield glass on the outer side in the vehicle width direction.

In the vehicle front-portion structure of the sixth aspect, at least a part of the wiper driver is positioned on the outer side in the vehicle width direction from the end of the front windshield glass on the outer side in the vehicle width direction. In this configuration, as compared with a configuration in which the wiper driver is positioned on the inner side in the vehicle width direction from the end of the front windshield glass on the outer side in the vehicle width direction, the wiper driven by the wiper driver can be easily disposed to the end side of the front windshield glass on the outer side in the vehicle width direction. In this manner, the front windshield glass can be easily wiped up to the end side of the front windshield glass on the outer side in the vehicle width direction.

As a vehicle front-portion structure of a seventh aspect, in the vehicle front-portion structure of any one of the first aspect to the fourth aspect, the die-cast framework portion may be provided integrally with a wheel arch in which a wheel is to be stored.

In the vehicle front-portion structure of the seventh aspect, the framework portion is provided integrally with the wheel arch in which the wheel is to be stored. In this configuration, as compared with a configuration in which the framework portion and the wheel arch are separate members, the number of components configuring the front portion of the vehicle can be prevented from increasing.

As a vehicle front-portion structure of an eighth aspect, in the vehicle front-portion structure of the seventh aspect, the die-cast framework portion may be provided integrally with a vehicle width direction extending portion that connects the wheel arches of a pair of right and left wheel arches in the vehicle width direction, the wheel arches being respectively provided on both sides in the vehicle width direction.

In the vehicle front-portion structure of the eighth aspect, the framework portion is provided integrally with the vehicle width direction extending portion that connects the right and left wheel arches in the vehicle width direction. In this configuration, as compared with a configuration in which the framework portion and the vehicle width direction extending portion are separate members, the number of components configuring the front portion of the vehicle can be prevented from increasing.

The vehicle front-portion structure according to the present disclosure has such an excellent effect that good visibility can be ensured even in the vehicle adopting the low-hood structure from the viewpoint of design.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view obtained by viewing a front portion of a vehicle of this embodiment from a front right side;

FIG. 2 is a perspective view obtained by viewing a right-side member portion from an inner side in a vehicle width direction;

FIG. 3 is a perspective view obtained by viewing a part of the right-side member portion in which a through-hole is formed, from an outer side in the vehicle width direction; and

FIG. 4 is a sectional view illustrating a section of the member portion taken along the line IV-IV of FIG. 2.

### DETAILED DESCRIPTION OF EMBODIMENTS

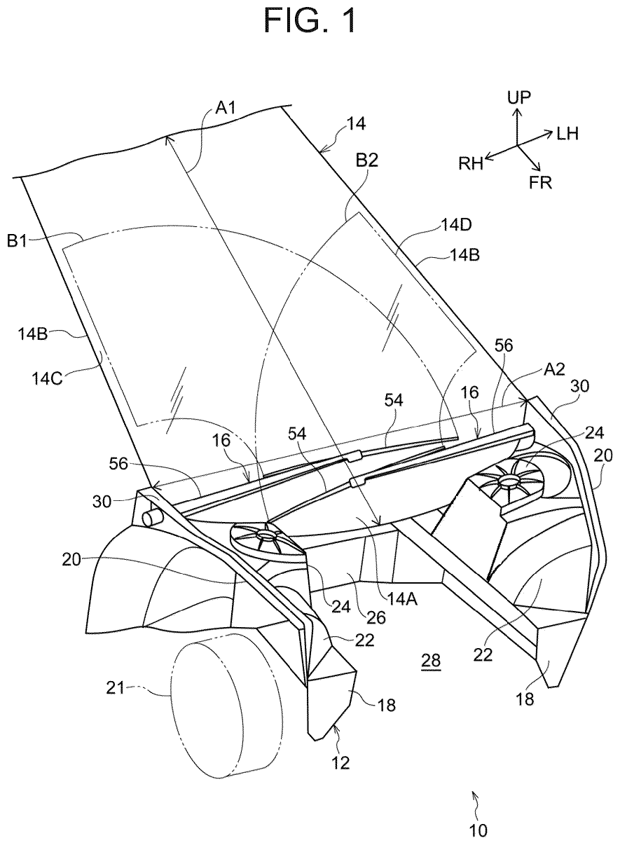

With reference to FIG. 1 to FIG. 4, description is given of a front portion 10 of a vehicle to which a vehicle front-portion structure according to an embodiment of the present disclosure is applied. It is to be noted that an arrow FR that is shown as appropriate in each of the drawings indicates a front side in a vehicle front-rear direction, an arrow UP indicates an upper side in a vehicle-height direction, an arrow RH indicates a right side in a vehicle width direction, and an arrow LH indicates a left side in the vehicle width direction. Further, in the following, when the description is given simply with the use of directions of front-rear, right-left, and up-down, unless otherwise specified, the directions respectively indicate the front-rear in the vehicle front-rear direction, the right-left in the vehicle right-left direction (the vehicle width direction), and the up-down in the vehicle-height direction.

As illustrated in FIG. 1, in the front portion 10 of the vehicle, a front-side framework portion 12 serving as a framework portion configuring a framework of the front portion 10 of the vehicle, a front windshield glass 14 that separates an inside of a vehicle cabin and an outside of the vehicle cabin, and a pair of right and left wiper devices 16 that wipes the front windshield glass 14 are provided.

The front-side framework portion 12 is, as an example, a die-cast framework portion in which portions to be described later are integrally molded with the use of an aluminum alloy. The front-side framework portion 12 includes a pair of right and left first member portions 18 extending in the front-rear direction. The right and left first member portions 18 are disposed at an interval in the vehicle width direction. Further, the front-side framework portion 12 includes second member portions 20 each serving as a member portion extending in the front-rear direction on the upper side and on the outer side in the vehicle width direction from a corresponding one of the right and left first member portions 18. Moreover, the front-side framework portion 12 includes a pair of right and left wheel arches 22 that connects the first member portion 18 and the second member portion 20. Right and left front wheels 21 of a pair of right and left front wheels 21 are to be stored in the respective right and left wheel arches 22. A part of each of the wheel arches 22 is a suspension tower portion 24 formed to swell to the inner side in the vehicle width direction. Further, the front-side framework portion 12 includes a vehicle width direction extending portion 26 that connects rear portions of the right and left wheel arches 22 in the vehicle width direction. It is to be noted that a space between the right and left first member portions 18, a space between the right and left second member portions 20, and a space between the right and left wheel arches 22 are a power unit room 28 in which a power unit or the like which is not shown is to be accommodated. Further, as an example, the first member portion 18 is a front side member, and the second member portion 20 is an apron upper member.

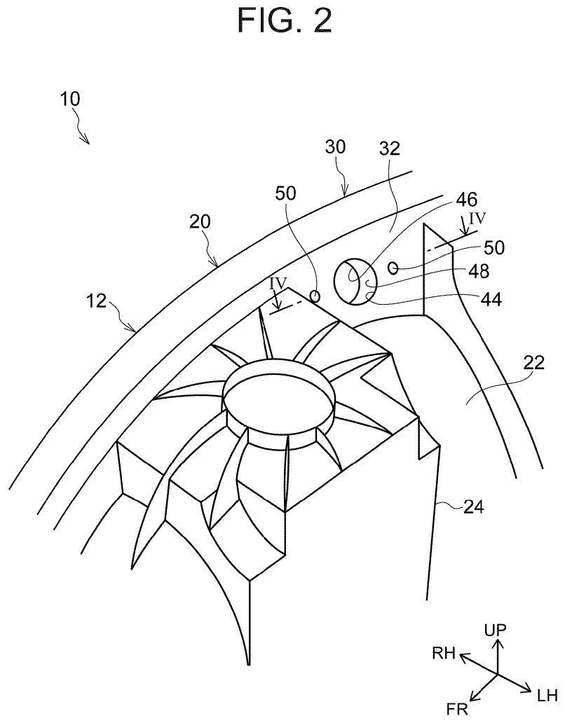

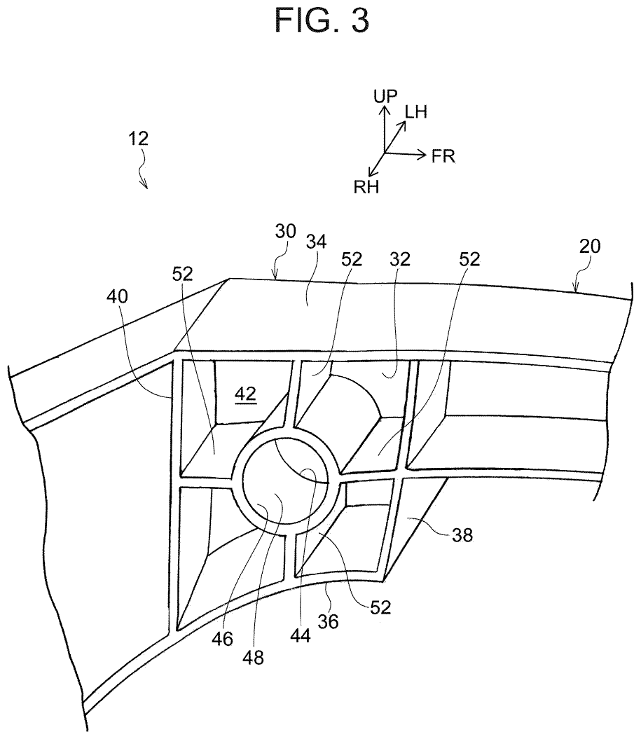

FIG. 2 and FIG. 3 illustrate the right-side second member portion 20. A part of the second member portion 20 rearward of the right-side suspension tower portion 24 is a wiper device fixing portion 30 to which a wiper device 16 to be described later is fixed. The wiper device fixing portion 30 includes an inner wall portion 32 serving as a vertical wall facing the power unit room 28 side. Further, as illustrated in FIG. 3, the wiper device fixing portion 30 includes an upper wall portion 34 extending from an upper end of the inner wall portion 32 toward the outer side in the vehicle width direction, and a lower wall portion 36 extending from a lower end of the inner wall portion 32 toward the outer side in the vehicle width direction. Moreover, the wiper device fixing portion 30 includes a front wall portion 38 extending from a front end of the inner wall portion 32 toward the outer side in the vehicle width direction, and a rear wall portion 40 extending from a rear end of the inner wall portion 32 toward the outer side in the vehicle width direction. An upper end and a lower end of the front wall portion 38 are respectively connected to a front end of the upper wall portion 34 and a front end of the lower wall portion 36. Further, an upper end and a lower end of the rear wall portion 40 are respectively connected to a rear end of the upper wall portion 34 and a rear end of the lower wall portion 36. In this manner, the inner wall portion 32, the upper wall portion 34, the lower wall portion 36, the front wall portion 38, and the rear wall portion 40 form an opened hollow sectional shape having a box-shaped hollow part 42.

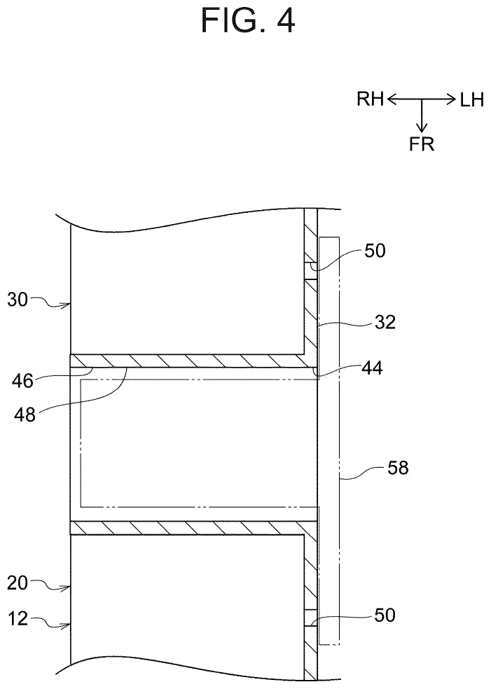

As illustrated in FIG. 2 to FIG. 4, in the inner wall portion 32, a circular opening 44 passing through the inner wall portion 32 is formed. Further, inside of the hollow part 42, a cylindrical portion 46 formed in a cylindrical shape is provided. The cylindrical portion 46 is disposed coaxially with the opening 44 formed in the inner wall portion 32. Further, an end portion of the cylindrical portion 46 on the inner wall portion 32 side is connected to the inner wall portion 32. In this manner, a range from the opening 44 formed in the inner wall portion 32 to the cylindrical portion 46 serves as a through-hole 48 passing in the vehicle width direction. The through-hole 48 is disposed on the outer side in the vehicle width direction from the suspension tower portion 24. It is to be noted that the through-hole 48 may be disposed on the outer side in the vehicle width direction from a member (a dash panel) that separates the inside of the vehicle cabin and the space between the right and left second member portions 20 provided outside of the vehicle cabin or a member (a cowl) that is stretched between rear end portions of the right and left second member portions 20. Further, as illustrated in FIG. 2 and FIG. 4, on both sides in the front-rear direction from the opening 44 in the inner wall portion 32, fastening holes 50 into which fastening members which are not shown are to be screwed are formed.

As illustrated in FIG. 3, inside of the hollow part 42, four reinforcement ribs 52 are provided. The first reinforcement rib 52 extends to connect, in the up-down direction, an upper end of the cylindrical portion 46 and an intermediate portion of the upper wall portion 34 in the front-rear direction. The second reinforcement rib 52 extends to connect, in the up-down direction, a lower end of the cylindrical portion 46 and an intermediate portion of the lower wall portion 36 in the front-rear direction. The third reinforcement rib 52 extends to connect, in the front-rear direction, a front end of the cylindrical portion 46 and an intermediate portion of the front wall portion 38 in the up-down direction. The fourth reinforcement rib 52 extends to connect, in the front-rear direction, a rear end of the cylindrical portion 46 and an intermediate portion of the rear wall portion 40 in the up-down direction. Further, ends of the four reinforcement ribs 52 on the inner side in the vehicle width direction are connected to the inner wall portion 32.

It is to be noted that, also in the left-side second member portion 20, a wiper device fixing portion 30 having a configuration similar to that of the right-side second member portion 20 is provided.

As illustrated in FIG. 1, the front windshield glass 14 of this embodiment is provided on the vehicle rear side from the right and left second member portions 20, and has a configuration in which a dimension A1 in the vehicle front-rear direction is set to be longer than a dimension A2 in the vehicle width direction. A middle portion in the vehicle width direction of a front end portion 14A of the front windshield glass 14 is positioned between the right and left wiper device fixing portions 30.

The wiper device 16 is configured to include a wiper 54 (a wiper blade), a wiper arm 56 that supports the wiper 54, and a wiper driver 58 (see FIG. 4) that tilts the wiper arm 56 within a determined range. Here, as illustrated in FIG. 4, most part of the wiper driver 58 is disposed inside of the through-hole 48. Further, a pair of fastening members which is not shown is provided, and the fastening members inserted through the wiper driver 58 are respectively screwed into the fastening holes 50 provided as a pair, and thus the wiper driver 58 (the wiper device 16) is fixed to the wiper device fixing portion 30. Further, as illustrated in FIG. 1 and FIG. 4, in a state in which the wiper driver 58 is fixed to the wiper device fixing portion 30, most part of the wiper driver 58 is positioned on the outer side in the vehicle width direction from an end 14B of the front windshield glass 14 on the outer side in the vehicle width direction. Further, a pivoting position of the wiper arm 56 is positioned on the inner side in the vehicle width direction from the through-hole 48. The pivoting position (the center of the pivoting) is provided between the wiper driver 58 and the wiper arm 56, and is a center of a rotational motion of the wiper arm 56 moving in a circumferential direction.

It is to be noted that FIG. 1 indicates, by a two-dot chain line B1, a range to be wiped by the wiper 54 of the wiper device 16 fixed to the wiper device fixing portion 30 of the right-side second member portion 20. The wiper 54 of the wiper device 16 fixed to the wiper device fixing portion 30 of the right-side second member portion 20 wipes a range from the front end portion 14A to a right-side end portion 14C of the front windshield glass 14. Further, FIG. 1 indicates, by a two-dot chain line B2, a range to be wiped by the wiper 54 of the wiper device 16 fixed to the wiper device fixing portion 30 of the left-side second member portion 20. The wiper 54 of the wiper device 16 fixed to the wiper device fixing portion 30 of the left-side second member portion 20 wipes a range from the front end portion 14A to a left-side end portion 14D of the front windshield glass 14.

### Actions and Effects of This Embodiment

Next, actions and effects of this embodiment are described.

As illustrated in FIG. 1 and FIG. 4, in the front portion 10 of the vehicle to which the vehicle front-portion structure of this embodiment is applied, in a state in which most part of the wiper driver 58 is disposed inside of the through-hole 48, the wiper driver 58 is fixed to the wiper device fixing portion 30. In this configuration, the wiper driver 58 can be disposed along a part on the outer side in the vehicle width direction in the front portion of the vehicle. In this manner, as compared with a configuration in which the wiper driver 58 is fixed to the cowl portion provided forward of the front windshield glass 14, a different vehicle design can be achieved. As an example, in the front portion 10 of the vehicle to which the vehicle front-portion structure of this embodiment is applied, it is possible to achieve a design having a configuration in which the dimension A1 of the front windshield glass 14 in the vehicle front-rear direction is longer than the dimension A2 thereof in the vehicle width direction. Further, even in a case of a vehicle adopting a low-hood structure from the viewpoint of design, as compared with the case in which the wiper driver 58 is disposed in a part on the inner side in the vehicle width direction in the front portion 10 of the vehicle, a wider wiping range of the wiper 54 can be ensured.

Further, in this embodiment, as illustrated in FIG. 3, the hollow part 42 is provided around the through-hole 48 in the wiper device fixing portion 30. In this configuration, as compared with a configuration in which a part around the through-hole 48 of the wiper device fixing portion 30 is solid, the front-side framework portion 12 can be reduced in weight. Further, the four reinforcement ribs 52 are provided around the through-hole 48 in the wiper device fixing portion 30. In this manner, the cylindrical portion 46 forming the through-hole 48 in the wiper device fixing portion 30 can be reinforced. Specifically, the tilt of the cylindrical portion 46 in the front-rear and up-down directions can be reduced by the four reinforcement ribs 52.

Further, in this embodiment, as illustrated in FIG. 1 and FIG. 4, in a state in which the wiper driver 58 is fixed to the wiper device fixing portion 30, most part of the wiper driver 58 is positioned on the outer side in the vehicle width direction from the end 14B of the front windshield glass 14 on the outer side in the vehicle width direction. In this configuration, as compared with a configuration in which the wiper driver 58 is positioned on the inner side in the vehicle width direction from the end 14B of the front windshield glass 14 on the outer side in the vehicle width direction, the wiper 54 driven by the wiper driver 58 can be easily disposed to the end 14B side of the front windshield glass 14 on the outer side in the vehicle width direction. In this manner, the front windshield glass 14 can be easily wiped up to the end side of the front windshield glass 14 on the outer side in the vehicle width direction.

Further, in this embodiment, as illustrated in FIG. 1, the front-side framework portion 12 is formed integrally with the wheel arch 22 in which the wheel is to be stored. In this configuration, as compared with a configuration in which the front-side framework portion 12 and the wheel arch 22 are separate members, the number of components configuring the front portion 10 of the vehicle can be prevented from increasing.

In addition thereto, the front-side framework portion 12 is formed integrally with the vehicle width direction extending portion 26 that connects the right and left wheel arches 22 in the vehicle width direction. In this configuration, as compared with a configuration in which the front-side framework portion 12 and the vehicle width direction extending portion 26 are separate members, the number of components configuring the front portion 10 of the vehicle can be prevented from increasing. Further, with the portions of the front-side framework portion 12 being integrally formed, the rigidity of the front-side framework portion 12 can be improved.

It is to be noted that this embodiment has described an example in which the front-side framework portion 12 has an integral configuration including the right and left wheel arches 22 and the vehicle width direction extending portion 26, but the present disclosure is not limited thereto. Whether to integrally form the portions of the front-side framework portion 12 or to use separate members may be set as appropriate in consideration of a manufacturing process of the front-side framework portion 12, a configuration of a mold, and the like.

Further, this embodiment has described an example in which most part of the wiper driver 58 is positioned on the outer side in the vehicle width direction from the end 14B of the front windshield glass 14 on the outer side in the vehicle width direction, but the present disclosure is not limited thereto. The position of the wiper driver 58 from the end 14B of the front windshield glass 14 on the outer side in the vehicle width direction may be set as appropriate in consideration of the design of the front windshield glass 14, the configuration of the front-side framework portion 12, and the like.

Further, this embodiment has described an example in which the tilt of the cylindrical portion 46 in the front-rear and up-down directions is prevented by the four reinforcement ribs 52, but the present disclosure is not limited thereto. For example, a rib extending in an oblique direction from the cylindrical portion 46 can be provided between the rib 52 extending in the up-down direction and the rib 52 extending in the front-rear direction.

Further, this embodiment has described a configuration in which the dimension A1 of the front windshield glass 14 in the vehicle front-rear direction is longer than the dimension A2 thereof in the vehicle width direction, but the present disclosure is not limited thereto. The dimension A2 of the front windshield glass 14 in the vehicle width direction with respect to the dimension A1 thereof in the vehicle front-rear direction may be set as appropriate in consideration of the design of the front windshield glass 14 and the like.

Further, this embodiment has described an example in which, in the state in which most part of the wiper driver 58 is disposed inside of the through-hole 48, the wiper driver 58 is fixed to the wiper device fixing portion 30, but the present disclosure is not limited thereto. For example, the wiper device 16 may be fixed in a state in which at least a part of a member configuring the wiper device 16 is disposed inside of the through-hole 48.

One embodiment of the present disclosure has been described above, but the present disclosure is not limited to the description above, and it is needless to say that various modifications other than those described above can be made without departing from the gist of the present disclosure.

What is claimed is:

1. A vehicle front-portion structure comprising:
a die-cast framework portion including
a pair of member portions extending in a vehicle front-rear direction at both side portions in a vehicle width direction in a front portion of a vehicle, each of the member portions having a part including a through-hole, and
a suspension tower portion provided to swell to an inner side in the vehicle width direction, the through-hole being disposed on an outer side in the vehicle width direction from the suspension tower portion;
a front windshield glass provided on a vehicle rear side from the member portions in the front portion of the vehicle, the front windshield glass separating an inside of a vehicle cabin of the vehicle and an outside of the vehicle cabin; and
a wiper device including
a wiper configured to wipe the front windshield glass, and
a wiper arm that supports the wiper and has a pivoting position that is positioned on the inner side in the vehicle width direction from the through-hole, the wiper device being fixed to each of the member portions in a state in which at least a part of the wiper device is disposed inside of the through-hole.

2. The vehicle front-portion structure according to claim 1, wherein
the wiper device includes a wiper driver configured to tilt the wiper arm, and
the wiper driver is fixed to each of the member portions in a state in which at least a part of the wiper driver is disposed inside of the through-hole.

3. The vehicle front-portion structure according to claim 1, wherein a dimension of the front windshield glass in the vehicle front-rear direction is longer than a dimension of the front windshield glass in the vehicle width direction.

4. The vehicle front-portion structure according to claim 1, wherein
each of the member portions has an opened hollow sectional shape in which the outer side in the vehicle width direction is opened, and the through-hole is provided in a vertical wall extending in the vehicle front-rear direction and a vehicle-height direction,
on the vertical wall, a cylindrical portion is provided to rise from a peripheral edge portion of the through-hole in a plate thickness direction of the vertical wall, and
reinforcement ribs that reinforce the cylindrical portion are integrally provided around the cylindrical portion.

5. The vehicle front-portion structure according to claim 4, wherein the reinforcement ribs extend in at least one of the vehicle front-rear direction and the vehicle-height direction.

6. The vehicle front-portion structure according to claim 2, wherein at least a part of the wiper driver is positioned on the outer side in the vehicle width direction from an end of the front windshield glass on the outer side in the vehicle width direction.

7. The vehicle front-portion structure according to claim 1, wherein the die-cast framework portion is provided integrally with a wheel arch in which a wheel is to be stored.

8. The vehicle front-portion structure according to claim 7, wherein the die-cast framework portion is provided integrally with a vehicle width direction extending portion that connects the wheel arches of a pair of right and left wheel arches in the vehicle width direction, the wheel arches being respectively provided on both sides in the vehicle width direction.
